(19) United States
(12) Patent Application Publication
(10) Pub. No.: US 2015/0319816 A1
(43) Pub. Date: Nov. 5, 2015

(54) SINGLE-WIRE DIMMING METHOD

(71) Applicant: National Formosa University, Yunlin County (TW)

(72) Inventors: Yu-Kai CHEN, Yunlin County (TW); Chau-Chung SONG, Chiayi City (TW); Yung-Chun WU, Kaohsiung City (TW); Chin-Hsiung CHANG, Taichung City (TW)

(21) Appl. No.: 14/699,441

(22) Filed: Apr. 29, 2015

(30) Foreign Application Priority Data
May 2, 2014 (TW) 103115751

(51) Int. Cl. H05B 33/08

(52) U.S. Cl. CPC H05B 33/0845; H05B 33/0818

(57) ABSTRACT

A single-wire dimming method is provided in the present invention. The method is adapted for a lamp with a first color light source and a second color light source. The method includes: providing a dimming control interface, wherein the power voltage is chopped when the dimming control interface is operated; dividing a period of the power voltage into a first phase period, a second phase period and a third phase period; chopping the power voltage at the first phase period when a user adjust the dimming control interface to turn on a first color light; chopping the power voltage at the second phase period when a user adjust the dimming control interface to turn on a second color light; chopping the power voltage at the third phase period when a user adjust the dimming control interface to turn on a mix color light, wherein the mix color light is to combine the first color light and the second color light.

This application claims priority of No. 103115751 filed in Taiwan R.O.C. on May 2, 2014 under 35 USC 119, the entire content of which is hereby incorporated by reference.

### BACKGROUND OF THE INVENTION

1. Field of the Invention

The present invention relates to the technology of dimmer, and more particularly to a single wire dimming method.

2. Related Art

Luminaries are important equipments for family and public sites. In the past, the main luminaries are incandescence bulb. Since the driving of the incandescence bulb is simple, the luminance thereof is dimmable by changing its supply voltage. However, the 90% of the energy would be transferred to useless heat, only less than 10% of the energy would be transferred to light. By comparison with the incandescence bulb, the fluorescent lamp has higher efficiency, close to 40%. And its heat generation is only one-sixth of heat generation of the incandescence bulb when the fluorescent lamp and the incandescence bulb are at the same luminance. Since the 10% of energy would be transferred to light by the incandescence bulb, many places have begun to phase out the incandescence bulb. Incandescence bulb is gradually replaced by fluorescent lamp, CCFL (Cold Cathode Fluorescent Lamp) or LED (Light Emitting Diode) lamp. The compact fluorescent bulb (energy saving light bulb) combines the fluorescent with the starting electrical circuit and adopts the standard lamp jack for replacing the normal incandescence bulb.

However, the incandescence bulb, including Halogen lamp, has continuous and average optical spectrum, it has higher color rendering index (CRI); the compact fluorescent bulb or the LED bulb has discrete optical spectrum, and it has lower CRI. CRI means the ability of the light source by which objects represent their own colors. The light source with low CRI would make people feels the object has bad looking, it also damage the eyesight and health.

In addition, the conventional dimmers are also adopted by many houses. In order to be compatible with the conventional dimmer of the incandescence bulb, to increase the CRI of the fluorescent lamp, CCFL and LED, and to save energy, a single-wire dimming method is provided in this invention.

### SUMMARY OF THE INVENTION

An object of the present invention is to provide a single wire dimming method, which providing a plurality of mixed lighting modes corresponding to a plurality of phase periods in which a period of AC voltage is divided. In addition, the method switches the mixed lighting modes by chopping AC waveform. Thus, user can easily uses a dimmer knob to control the mixed lighting modes, and the light adjustment would become more intuitive.

In view of this, the present invention provides a single-wire dimming method adapted for a dimmable lamp. The dimmable lamp comprises at least a first color lamp and a second color lamp, wherein a control circuit of the dimmable lamp receives a power voltage, and controls the first color lamp and a second color lamp. The single-wire dimming method comprises: providing a dimming interface, wherein the power voltage is chopped when the dimming interface is operated; dividing a AC period of the power voltage into a first phase period, a second phase period and a third phase period; chopping the power voltage at the first phase period when a user adjusts the dimmable lamp to show a first color light by the dimmable lamp; chopping the power voltage at the third phase period when a user adjusts the dimmable lamp to show a second color light by the dimmable lamp; and chopping the power voltage at the second phase period when a user adjusts the dimmable lamp to show a mixed color light by the dimmable lamp, wherein the mixed color light is mixed by the first color light and the second color light.

According to the single-wire dimming method in a preferred embodiment of the present invention, when a user adjusts the dimmable lamp to show the first color light, the method further comprises: determining the luminance of the first color light according to a chopped phase in the first phase period of the power voltage. When a user adjusts the dimmable lamp to show the second color light, the method further comprises: determining the luminance of the second color light according to a chopped phase in the third phase period of the power voltage. When a user adjusts the dimmable lamp to show the mixed color light, the method further comprises: determining the luminance of the first color light and the second color light according to a chopped phase in the second phase period of the power voltage.

According to the single-wire dimming method in a preferred embodiment of the present invention, the first color lamp is a first color LED, and the second color lamp is a second color LED. The single-wire dimming method further comprises: providing a first pulse width modulation (PWM) signal; providing a second pulse width modulation (PWM) signal; providing a first switch, being electrically connected to the first color LED; providing a second switch, being electrically connected to the second color LED; determining a duty cycle of the first PWM signal according to a phase difference between the chopped phase in the second phase period of the power voltage and a first boundary phase of the second phase period when the power voltage is chopped at the second phase period; and determining a duty cycle of the second PWM signal according to a phase difference between the chopped phase in the second phase period of the power voltage and a second boundary phase of the second phase period when the power voltage is chopped at the second phase period. The duty cycle of the first PWM signal determines the turn-on time of the first switch in a PWM period, and the duty cycle of the second PWM signal determines the turn-on time of the second switch in the PWM period.

According to the single-wire dimming method in a preferred embodiment of the present invention, the first color lamp is a warm white light lamp, and the second color lamp is a white light lamp. The step of providing the dimming interface further comprises: providing a dimmer knob. The dimmer knob comprises a first adjusting boundary, a second adjusting boundary, a third adjusting boundary and a fourth adjusting boundary. The first phase period comprises a first phase boundary and the second phase boundary, the second phase period comprises a first phase boundary and the second phase boundary, and the third phase period comprises a first phase boundary and the second phase boundary. The first adjusting boundary corresponds to the first phase boundary of the first phase period, the second adjusting boundary corresponds to the first phase boundary of the second phase period and the second phase boundary of the first phase period, the third adjusting boundary corresponds to the second phase boundary of the second phase period and the first phase boundary of the third phase period, and the fourth adjusting boundary corresponds to the second phase boundary of the third phase period. The power voltage is chopped at the first phase period when a user turns the dimmer knob and a pointer of the dimmer knob stops at a position between the first adjusting boundary and the second adjusting boundary. The power voltage is chopped at the second phase period when a user turns the dimmer knob and the pointer of the dimmer knob stops at a position between the second adjusting boundary and the third adjusting boundary. The power voltage is chopped at the third phase period when a user turns the dimmer knob and the pointer of the dimmer knob stops at a position between the third adjusting boundary and the fourth adjusting boundary.

Moreover, the present invention provides a single-wire dimming method adapted for a dimmable lamp. The dimmable lamp comprises N color lamps, wherein a control circuit of the dimmable lamp receives a power voltage, and controls the N color lamps. The single-wire dimming method comprises: providing a dimming interface, wherein the power voltage is chopped when the dimming interface is operated; dividing a AC period of the power voltage into M phase periods, wherein M=C(N, 1)+C(N, 2)+ . . . +C(N, N), where C (a, b)=a!/[b!×(b−a)!]; providing M light blend modes corresponding to the M phase period; performing the I^{th} light blend mode by the dimmable lamp when a user adjust the dimmable lamp to chop the power voltage at the I^{th} phase period. The I^{th} light blend mode is to mix lights of K color lamps from N color lamps, wherein N, M, K, I, a, b are nature numbers, and N is greater than or equal to K, and M is greater than or equal to I.

According to the single-wire dimming method in a preferred embodiment of the present invention, the step of providing the dimming interface further comprises: providing a dimmer knob, wherein the dimmer knob comprises M+1 adjusting boundaries, wherein each phase period comprises a first phase boundary and the second phase boundary, wherein the I^{th} adjusting boundary corresponds to the first phase boundary of the I^{th} phase period, wherein the (I+1)^{th} adjusting boundary corresponds to the first phase boundary of the (I+1)^{th} phase period and the second phase boundary of the I phase period, wherein the power voltage is chopped at the Q^{th} phase period when a user turns the dimmer knob and a pointer of the dimmer knob stops at a position between the Q^{th} adjusting boundary and the (Q+1)^{th} adjusting boundary, wherein Q is a nature number, and M is greater than Q.

The spirit of the present invention resides in providing a plurality of mixed lighting modes corresponding to a plurality of phase periods in which a period of AC voltage is divided. In addition, the method switches the mixed lighting modes by chopping AC waveform in a single power wire. Thus, user can easily uses a dimmer knob to control the mixed lighting modes, and the light adjustment would become more intuitive.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates a diagram depicting a system adopted by the single-wire dimming method according to a preferred embodiment of the present invention.

FIG. 2 illustrates a diagram depicting a relationship between the dimming knob 104 and the waveforms of the power voltage according to a preferred embodiment of the present invention.

FIG. 3 illustrates a circuit diagram depicting a portion of the control circuit 112 according to a preferred embodiment of the present invention.

FIG. 4 illustrates a flow chart depicting a single-wire dimming method according to a preferred embodiment of the present invention.

FIG. 5 illustrates a diagram depicting a system adopted by the single-wire dimming method according to a preferred embodiment of the present invention.

FIG. 6 illustrates a diagram depicting a relationship between the dimming knob 504 and the waveforms of the power voltage according to a preferred embodiment of the present invention.

FIG. 7 illustrates a diagram depicting a knob 700 for mixing three color lights according to a preferred embodiment of the present invention.

FIG. 8 illustrates a diagram depicting a dimming sequence by the knob 700 for mixing three color lights according to a preferred embodiment of the present invention.

FIG. 9 illustrates a diagram depicting a relationship between the dimming knob in FIG. 7 and the waveforms of the power voltage according to a preferred embodiment of the present invention.

FIG. 10 illustrates a circuit diagram depicting a portion of the control circuit 112 according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

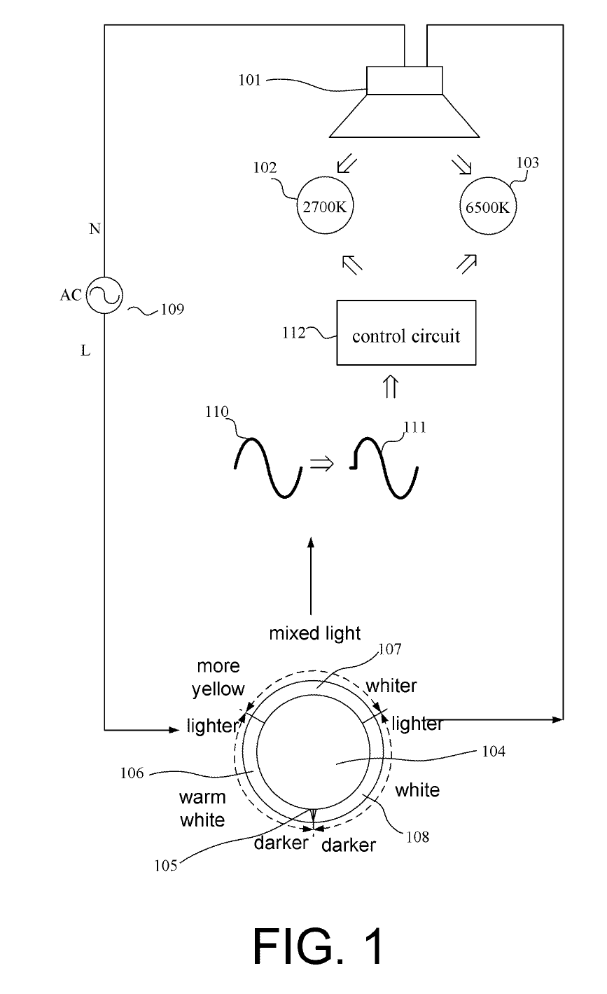

FIG. 1 illustrates a diagram depicting a system adopted by the single-wire dimming method according to a preferred embodiment of the present invention. Referring to FIG. 1, in this embodiment, the dimmable lamp 101 includes a first color lamp 102 and a second color lamp 103. In order that people having ordinary skill in the art understands the present invention, in this embodiment, it is assumed that the first color lamp 102 is implemented by the 2700K warm white series LEDs. In addition, it is assumed that the second color lamp 103 is implemented by the 6500K white series LEDs. Furthermore, in this embodiment, the system further includes a dimming interface 104, wherein the dimming interface 104 is implemented by a dimmer knob 104. The dimmer knob 104 includes a pointer 105, a first label area 106, a second label area 107 and a second label area 108. The dimmer knob 104 is for adjusting the chopped phase of the AC voltage. Moreover, in order that people having ordinary skill in the art can understand the present invention, in this embodiment, an AC power source 109, a live wire L and a neutral wire N are illustrated.

The dimmable lamp 101 is coupled to the neutral wire N of the AC power source 109. The dimmer knob 104 is coupled to the live wire L of the power source 109. The dimmer knob 104 is for chopping the AC voltage 110. Please referring to the chopped power voltage 11, the chopped power voltage 111 is supplied to the control circuit 112 of the dimmable lamp 101. The control circuit 112 of the dimmable lamp 101 controls the luminance or the color temperature of the dimmable lamp 101 according to the chopped phase of the power voltage 111.

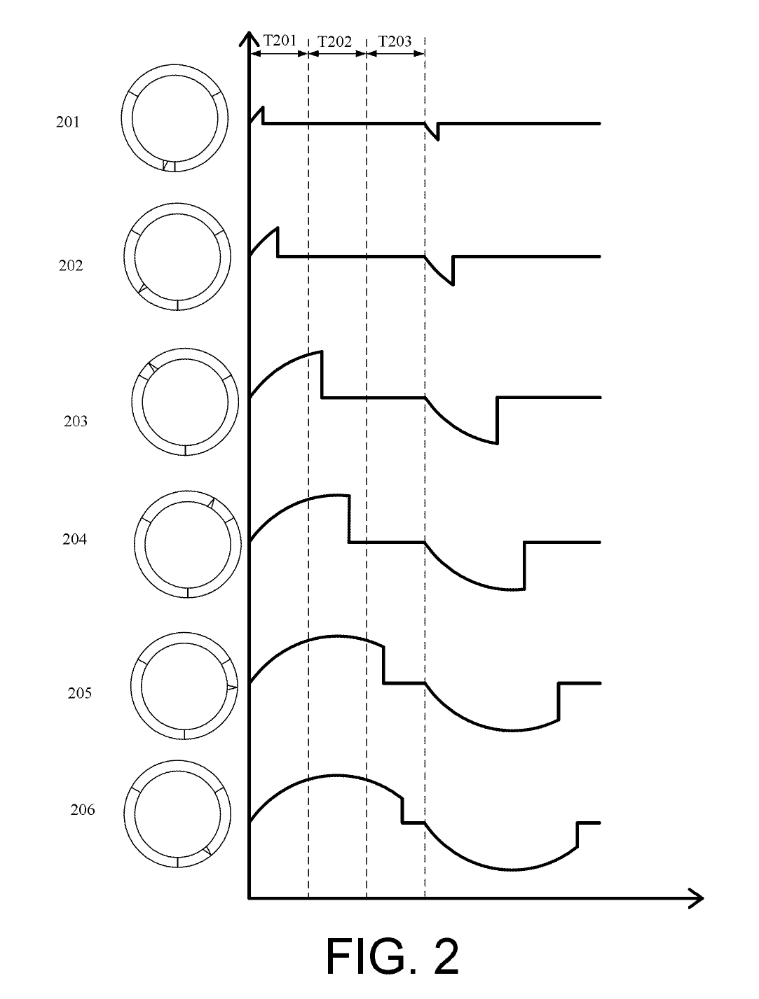

FIG. 2 illustrates a diagram depicting a relationship between the dimming knob 104 and the waveforms of the power voltage according to a preferred embodiment of the present invention. Referring to FIG. 2, the label 201 shows a power voltage waveform when the 2700K warm white light of the dimmable lamp 101 is lit up; the label 202 shows a power voltage waveform when the 2700K warm white light of the dimmable lamp 101 is lit up with higher luminance than the luminance of the power voltage waveform 201; the label 203 shows a power voltage waveform when the mixed light mixed with 2700K warm white light and 6500K white light of the dimmable lamp 101 is lit up; the label 204 shows a power voltage waveform when the mixed light mixed with 2700K warm white light and 6500K white light of the dimmable lamp 101 is lit up, wherein the luminance of 6500K white light is higher than the luminance of 2700K warm white light; the label 205 shows a power voltage waveform when the 6500K white light of the dimmable lamp 101 is lit up; the label 206 shows a power voltage waveform when the 6500K white light of the dimmable lamp 101 is lit up with higher luminance than the luminance of the power voltage waveform 205.

Further, in order that people having ordinary skill in the art can understand the present invention, in this embodiment in FIG. 2, it is annotated a first phase period T201, a second phase period T202 and a third phase period T203. In other words, in this embodiment, the period of the power voltage is divided into three phase periods. Each of the phase periods T201, T202 and T203 respectively represent a pure 2700K warm white light, a mixed light and a pure 6500K white light.

Referring to FIG. 2 and FIG. 1, when user turns the dimmer knob 104 clockwise and its pointer points to the pure 2700K warm white light area, the power voltage 201 is chopped at first phase period T201. When the control circuit 112 receives the chopped power voltage 201, the control circuit 112 controls the 2700K warm white series LEDs to gradually light up. When user continues to turn the dimmer knob 104 clockwise, the chopped phase of the power voltage would be shifted and the chopped power voltage is for example the waveform of the power voltage 202. At this time, the control circuit 112 controls the 2700K warm white series LEDs 102 to emit stronger light according to the chopped phase of the power voltage 202.

When user continues to turn the dimming knob 104 and its pointer stops at the mixed light area, the chopped phase of the power voltage would be shifted and the chopped power voltage is for example the waveform of the power voltage 203. At this time, the power voltage 203 is chopped at the second phase period T202. The control circuit 112 controls the 2700K warm white series LEDs 102 and the 6500K white series LEDs 103 to light up according to the chopped power voltage 203. Since the chopped phase of the power voltage 203 is close to the boundary between the first phase period T201 and the second period T202, the control circuit 112 controls the 2700K warm white series LEDs 102 to emit stronger light, and the control circuit 112 controls the 6700K white series LEDs 103 to emit weaker light.

When user continues to turn the dimming knob 104 clockwise, the chopped phase of the power voltage would be shifted and the chopped power voltage is for example the waveform of the power voltage 204. At this time, the chopped phase of the power voltage 204 is still at the second phase period T202. The control circuit 112 controls the 2700K warm white series LEDs 102 and the 6500K white series LEDs 103 to light up. Since the chopped phase of the power voltage 204 is close to the boundary between the second phase period T202 and the third period T203, the control circuit 112 controls the 2700K warm white series LEDs 102 to emit weaker light, and the control circuit 112 controls the 6700K white series LEDs 103 to emit stronger light.

When user continues to turn the dimming knob 104 clockwise and its pointer stop at the white light area, the chopped phase of the power voltage would be shifted and the chopped power voltage is for example the waveform of the power voltage 205. At this time, the power voltage 205 is chopped at the third phase period T203. The control circuit 112 controls the 6500K white series LEDs 103 to light up, and controls the 2700K warm white series LEDs 102 to shut down. Since the chopped phase of the power voltage 205 is close to the boundary between the second phase period T202 and the third period T203, the control circuit controls the 6700K white series LEDs 103 to emit stronger light.

When user continues to turn the dimming knob 104 clockwise, and its pointer stop at the white light area, the chopped phase would be shifted and the chopped power voltage is for example the waveform of the power voltage 206. At this time, the power voltage 206 is chopped at the third phase period T203. Since the chopped phase of the power voltage 206 deviates from the second phase period T202, the control circuit controls the 6700K white series LEDs 103 to emit weaker light according to the chopped phase of the power voltage 206.

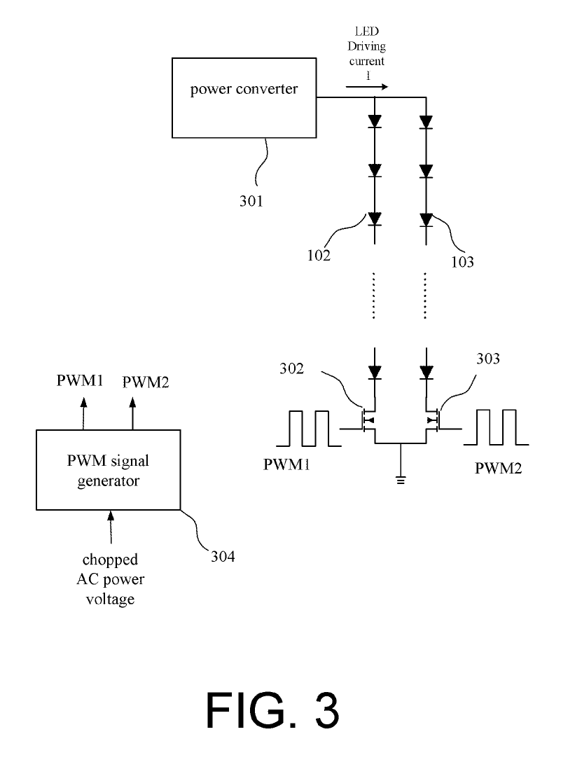

FIG. 3 illustrates a circuit diagram depicting a portion of the control circuit 112 according to a preferred embodiment of the present invention. Referring to FIG. 3, the control circuit 112 includes a power converter 301, a first switch 302, a second switch 303 and a pulse width modulation (PWM) signal generator 304. The power converter 301 is used for providing the driving current for the 6500K white series LEDs 103 and the 2700K warm white series LEDs 102. The PWM signal generator 304 is used for providing the first PMW signal PWM1 and the second PWM signal PWM2 respectively to the first switch 302 and the second switch 303.

Referring to FIG. 2 and FIG. 3, when user turns the pointer of the dimming knob 104 and the pointer stops at the warm white area, the control circuit 112 receives the chopped power voltage 201, the control circuit 112 controls the 2700K warm white series LEDs 102 to light up. At this time, the PWM signal generator 304 adjust the duty cycle of the first PWM signal PWM1 according to the chopped power voltage 201. In addition, the PWM signal generator 304 adjust the duty cycle of the second PWM signal PWM2 to 0. At this time, no current flows through the 6500K white series LEDs 103. Therefore, the 6500K white series LEDs 103 is not illuminated.

When user continues to turn the pointer of the dimming knob 104 clockwise, the chopped phase of the power voltage is shifted and the chopped power voltage is for example the waveform of the power voltage 202. At this time, the PWM signal generator 304 adjusts the first PWM signal PWM1 to increase its duty cycle such that the current flowing through the 2700K warm white series LEDs 102 is increased. Further, the PWM signal generator 304 adjusts the duty cycle of the second PWM signal PWM2 to 0 according to the chopped power voltage 202. At this time, no current flows through the 6500K white series LEDs 103. Therefore, the 6500K white series LEDs 103 is not illuminated. When user continues to turn the pointer of the dimming knob 104 to the boundary between the warm white light area and the mixed light area, the power voltage is chopped at the boundary between the first phase period T201 and the second phase period T202. The PWM signal generator 304 adjusts the duty cycle of the first PWM signal PWM1 to 100%, and the PWM signal generator 304 adjusts the duty cycle of the second PWM signal PWM2 to 0.

When user continues to turn the pointer of the dimming knob 104 clockwise and the pointer stops at the mixed light area, the chopped phase of the power voltage is shifted and the chopped power voltage is for example the waveform of the power voltage 203. At this time, the power voltage 203 is chopped at the second phase period T202. The control circuit 112 controls the 2700K warm white series LEDs 102 and the 6500K white series LEDs 103 to light up according to the chopped power voltage 203. In addition, the PWM signal generator 304 adjusts the duty cycle of the first PWM signal PWM1 and the duty cycle of the second PWM signal PWM2 according to the chopped power voltage 203, wherein the first PWM signal PWM1 and the second PWM signal PWM2 have inverted phases from each other. At this time, since the chopped phase of the power voltage 203 is close to the boundary between the first phase period T201 and the second phase period T202, the duty cycle of the first PWM signal PWM1 is greater than the duty cycle of the second PWM signal PWM2.

When user continues to turn the pointer of the dimming knob 104, and the pointer stops at the mixed light area, the chopped phase of the power voltage is shifted and the chopped power voltage is for example the waveform of the power voltage 204. At this time, the power voltage 204 is chopped at the second phase period T202. The control circuit 112 controls the 2700K warm white series LEDs 102 and the 6500K white series LEDs 103 to light up according to the chopped power voltage 204. The PWM signal generator 304 adjusts the duty cycle of the first PWM signal PWM1 and the duty cycle of the second PWM signal PWM2 according to the chopped power voltage 204, wherein the first PWM signal PWM1 and the second PWM signal PWM2 have inverted phases from each other. At this time, since the chopped phase of the power voltage 204 is close to the boundary between the third phase period T203 and the second phase period T202, the duty cycle of the second PWM signal PWM2 is greater than the duty cycle of the first PWM signal PWM1.

When user continues to turn the pointer of the dimming knob 104 and the pointer stops at the boundary between the mixed light area and the white light area. At this time, the power voltage is chopped at the boundary between the second phase period T202 and the third phase period T203. The PWM signal generator 304 adjusts the duty cycle of the second PWM signal PWM2 to 100% and adjusts the duty cycle of the first PWM signal PWM1 to 0. Thus, the dimmable lamp 101 emits the 6500K white light.

When user continues to turn the pointer of the dimming knob 104 clockwise, and the pointer stops at the white light area, the chopped phase of the power voltage is shifted and the chopped power voltage is for example the waveform of the power voltage 205. At this time, the power voltage 205 is chopped at the third phase period T203. The control circuit 112 controls the 6500K white series LEDs 103 to light up, and controls the 2700K warm white series LEDs 102 to shut down according to the chopped power voltage 205. At this time, the PWM signal generator 304 adjusts the duty cycle of the second PWM signal PWM2 to reduce the duty cycle of the second PWM signal PWM2 according to the chopped power voltage 205, and the PWM signal generator 304 adjusts the duty cycle of the first PWM signal PWM1 to 0.

When the user continues to turn the pointer of the dimming knob 104 and the pointer stops at the white light area, the chopped phase of the power voltage is shifted and the chopped power voltage is for example the waveform of the power voltage 206. At this time, the power voltage 206 is chopped at the third phase period T203. Since the chopped phase of the power voltage 206 deviates from the second phase period T202, the PWM signal generator 304 adjusts the second PWM signal PWM2 to further reduce the duty cycle of the second PWM signal PWM2 according to the chopped power voltage 206, and the PWM signal generator 304 adjusts the duty cycle of the first PWM signal PWM1 to 0.

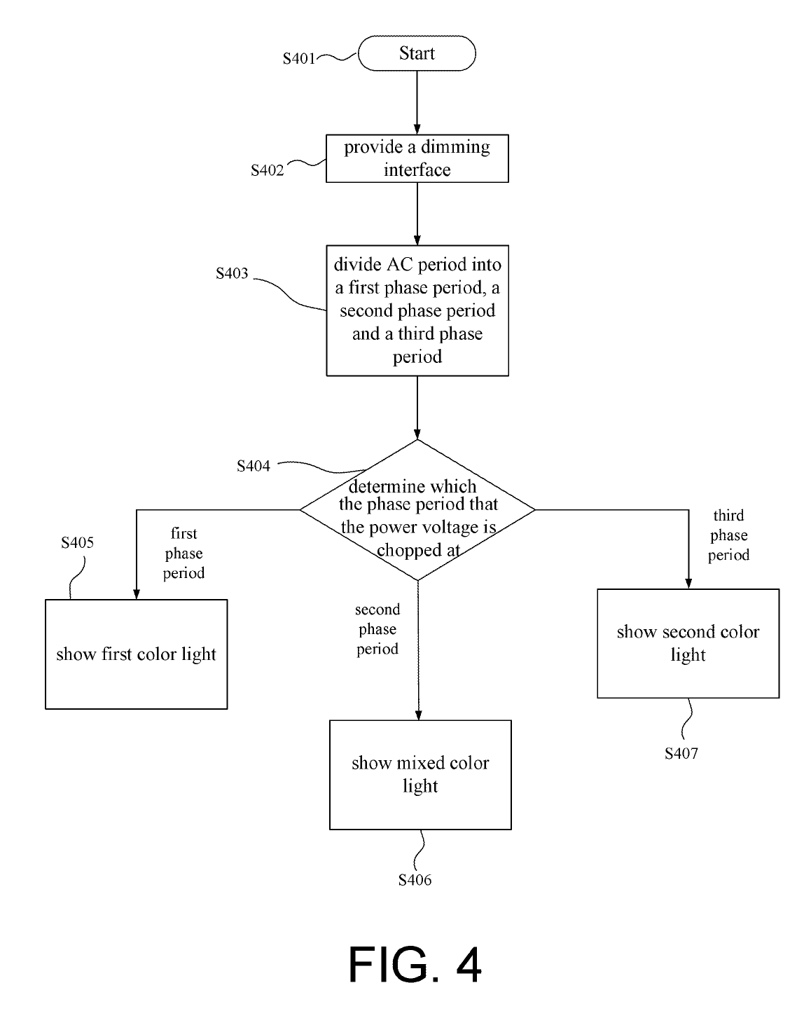

In the abovementioned embodiments of the dimming method, people having ordinary skill in the art should know that the control circuit controls the lamp according to the chopped power voltage since the control circuit receives the chopped power voltage. Thus, the dimming method can be adapted for single-wire control. Further, it can generalize a dimming method from the abovementioned embodiments. FIG. 4 illustrates a flow chart depicting a single-wire dimming method according to a preferred embodiment of the present invention. Referring to FIG. 4, the single-wire dimming method includes the steps as follow.

In step S401, the method starts.

In step S402, a dimming control interface is provided, such as the dimming knob as shown in FIG. 1. When user operates the dimming control interface, the power voltage is chopped.

In step S403, an AC period is divided into a first phase period, a second phase period and a third phase period. The examples of the first phase period T201, the second phase period T202 and the third phase period T203 are as shown in FIG. 2.

In step S404, it is determined one of the phase periods at which the power voltage is chopped. When the power voltage is chopped at the first phase period, the step S405 is performed. When the power voltage is chopped at the second phase period, the step S406 is performed. When the power voltage is chopped at the third phase period, the step S407 is performed.

In step S405, the dimmable lamp shows a first color light when the power voltage is chopped at the first phase period. In this embodiment, the first color light is the 2700K warm white light.

In step S406, the dimmable lamp shows a mixed color light when the power voltage is chopped at the second phase period. In this embodiment, the mixed color light is mixed by the 2700K warm white light and the 6500K white light.

In step S407, the dimmable lamp shows a second color light when the power voltage is chopped at the third phase period. In this embodiment, the second color light is the 6500K white light.

Moreover, in the step S405, the luminance of the first color light is determined according to the chopped phase of the power voltage in the first phase period. For example, the first phase period T201 has a first phase boundary and a second phase boundary. It is assumed that the first phase boundary of the first phase period T201 is the 0 degree, and the second phase boundary of the first phase period T201 is 60 degrees, which is also the boundary between the first phase period T201 and the second phase period T202. In the abovementioned embodiment, the more the chopped phase of the power voltage inclines to the first phase boundary of the first phase period T201, the darker the first color light (2700K warm white light) is. The more the chopped phase of the power voltage inclines to the second phase boundary of the first phase period T201, the lighter the first color light (2700K warm white light) is.

Similarly, in the step S406, the mixing ratio of the first color light and the second color light is determined according to the chopped phase of the power voltage in the second phase period. For example, the second phase period T202 has a first phase boundary and a second phase boundary. It is assumed that the first phase boundary of the second phase period T202 is the boundary between the first phase period T201 and the second phase period T202, which is 60 degrees, and the second phase boundary of the second phase period T202 is the boundary between the second phase period T202 and the third phase period T203, which is 120 degrees. In the abovementioned embodiment, if the chopped phase of the power voltage is closer to the first phase boundary of the second phase period T202, the proportion of the first color light (2700K warm white light) is higher and the proportion of the second color light (6500K white light) is lower. On the contrary, the proportion of the first color light (2700K warm white light) is lower and the proportion of the second color light (6500K white light) is higher.

Similarly, in the step S407, the luminance of the second color light is determined according to the chopped phase of the power voltage in the third phase period. For example, the third phase period T203 has a first phase boundary and a second phase boundary. It is assumed that the first phase boundary of the third phase period T203 is the boundary between the second phase period T202 and the third phase period T203, which is 120 degrees, and the second phase boundary of the third phase period T203 is 180 degrees of the AC power voltage. In the abovementioned embodiment, the more the chopped phase of the power voltage inclines to the first phase boundary of the third phase period T203, the lighter the second color light (6500K warm white light) is. The more the chopped phase of the power voltage inclines to the second phase boundary of the third phase period T203, the darker the first color light (2700K warm white light) is.

In the abovementioned embodiment, the 2700K warm white series LEDs and the 6500K white series LEDs are adopted to be an example. People having ordinary skill in the art should know that CCFL or fluorescent lamp can be adopted besides the LEDs. Thus, the present invention is not limited thereto. Furthermore, the color of the lamp is not limited to 2700K and 6500K. It may adopt red LED lamp, green LED lamp and so on. Thus, the present invention is not limited thereto. Moreover, in the abovementioned embodiment, the adjustment of the luminance and the color temperature by one control interface is disclosed. People having ordinary skill in the art should know that the designer can also design one control interface for determining color of the lamp, and another for determining its luminance or its mixed ratio. The present invention is not limited to the adjustment of the luminance and the color temperature.

In order that people having ordinary skill in the art can understand the present invention, the following embodiment adopts a red color LED lamp, a green color LED lamp and a blue color LED lamp to be an example.

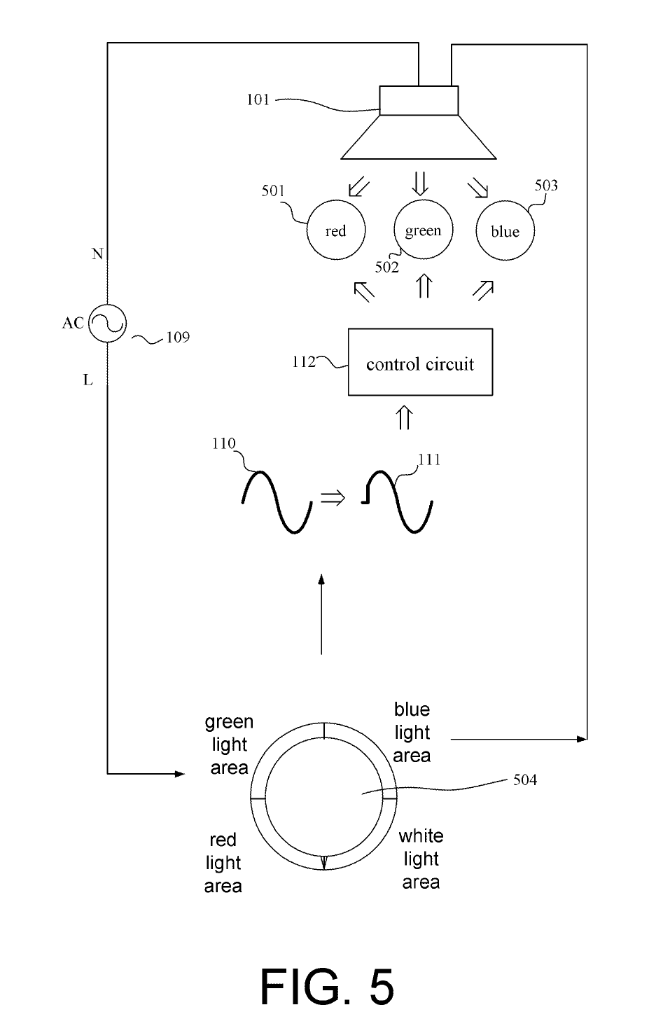

FIG. 5 illustrates a diagram depicting a system adopted by the single-wire dimming method according to a preferred embodiment of the present invention. Referring to FIG. 5, in this embodiment, it is assumed that the dimmable lamp 101 includes a first color lamp 501, a second color lamp 502 and a third color lamp 503. Similarly, it is assumed that the first color lamp 501, the second color lamp 502 and the third color lamp 503 respectively are the red lamp, the green lamp and the blue lamp in this embodiment. Since the system and the hardware in FIG. 5 are similar to that in FIG. 1, the detail description is omitted. Comparing with the system in FIG. 1, the dimming knob 504 is divided into four areas.

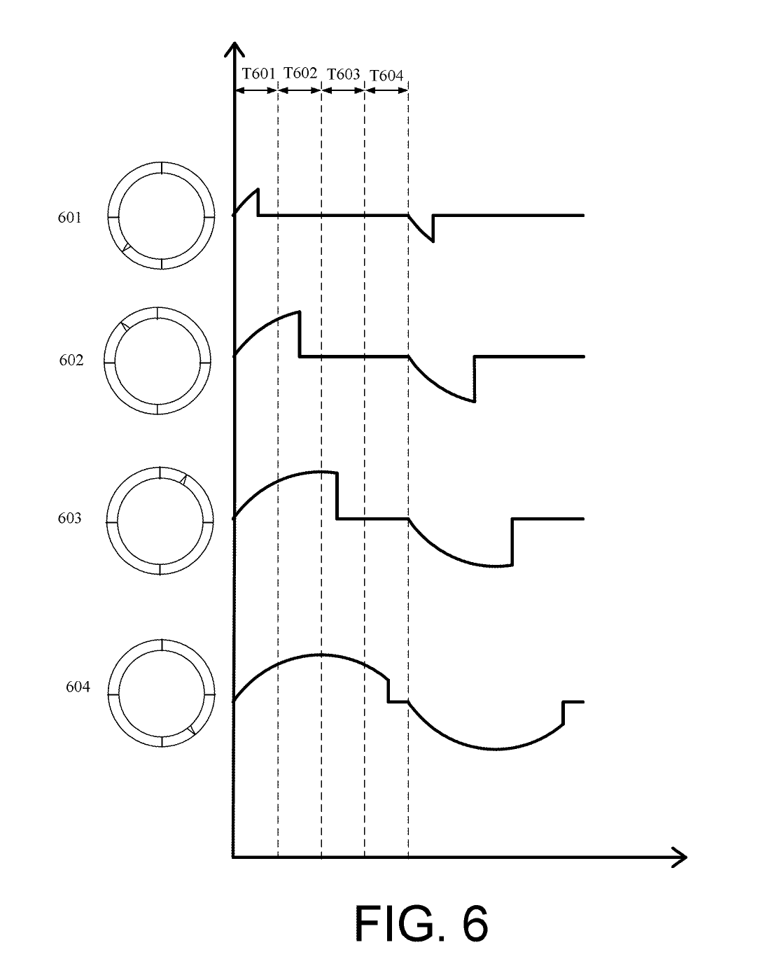

FIG. 6 illustrates a diagram depicting a relationship between the dimming knob 504 and the waveforms of the power voltage according to a preferred embodiment of the present invention. Referring to FIG. 6, the label 601 represents the waveform of the power voltage when the dimmable lamp 101 shows the red light; the label 602 represents the waveform of the power voltage when the dimmable lamp 101 shows the green light; the label 603 represents the waveform of the power voltage when the dimmable lamp 101 shows the blue light; the label 604 represents the waveform of the power voltage when the dimmable lamp 101 shows the white light.

In addition, in order that the people having ordinary skill in the art understands the present invention, in the embodiment of FIG. 6, the first phase period T601, the second phase period T602, the third phase period T603 and the fourth phase period T604 are annotated. In other words, in this embodiment, the period of the power voltage is divided into the first phase period T601, the second phase period T602, the third phase period T603 and the fourth phase period T604. In this embodiment, it is assumed that the first phase period T601 represents the red light, the second phase period T602 represents the green light, the third phase period T603 represents the blue light, and the fourth phase period T604 represents the white light.

Referring to FIG. 5 and FIG. 6, when user turns the pointer of the dimming knob 504 clockwise and the pointer points to the red light area, the power voltage is chopped at the first phase period T601. When the control circuit 112 receives the chopped power voltage 601, the control circuit 112 lights the red lamp 501 up. Similarly, in this embodiment, the control circuit 112 determines the luminance of the red lamp 501 according to the chopped phase of the power voltage 601. Since the detail description is described in the aforementioned embodiment, the detail description is omitted.

When user turns the pointer of the dimming knob 504 clockwise and the pointer points to the green light area, the power voltage is chopped at the second phase period T602. When the control circuit 112 receives the chopped power voltage 602, the control circuit 112 lights the green lamp 502 up. When user turns the pointer of the dimming knob 504 clockwise and the pointer points to the blue light area, the power voltage is chopped at the third phase period T603. When the control circuit 112 receives the chopped power voltage 603, the control circuit 112 lights the blue lamp 503 up. When user turns the pointer of the dimming knob 504 clockwise and the pointer points to the white light area, the power voltage is chopped at the fourth phase period T604. When the control circuit 112 receives the chopped power voltage 603, the control circuit 112 lights the red lamp 501, the green lamp 502 and the blue lamp 503 up. Similarly, in this embodiment, the control circuit determines the luminance of the green, the blue or the white light respectively according to the chopped phases of the power voltage 602, 603 or 604. Since the detail description is described in the aforementioned embodiment, the detail description is omitted.

The abovementioned embodiment adopts the first phase period T601, the second phase period T602, the third phase period T603 and the fourth phase period T604 to represent the red light, the green light, the blue light and the white light. People having ordinary skill in the art should know that mixing the red, the green and the blue lights can obtain the following color lights: the red light, the green light, the blue light, the red plus green light, the green plus blue light, the red plus blue light and the red plus green plus blue light. The following equation can be used for representing the number of the color modes:

M=C(N,1)+C(N,2)+ . . . +C(N,N) (1)

wherein M is the number of the color modes, N is the number of the color lamps. The operation C(N, k) represents the number of k-combinations from N elements. If 3 is substituted into N, the number of the color modes M is equal to 7.

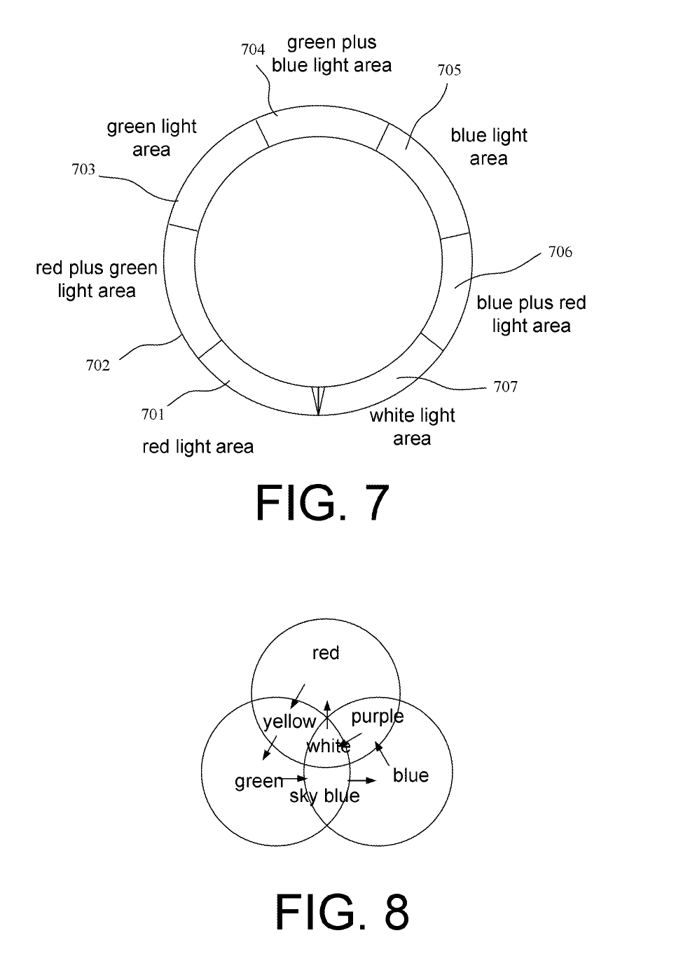

In other words, the abovementioned embodiment adopts four phase periods T601, T602, T603 and T604 to be an example, but people having ordinary skill in the art should know three different color lamps includes seven mixed light modes at most according to the abovementioned equation (1). FIG. 7 illustrates a diagram depicting a dimming knob for mixing three color lights according to a preferred embodiment of the present invention. Referring to FIG. 7, the dimming knob is divided into seven labeled areas, the first labeled area 701 is the red area; the second labeled area 702 is the red plus green area; the third labeled area 703 is the green area; the fourth labeled area 704 is the green plus blue area; the fifth labeled area 705 is the blue area; the sixth labeled area 706 is the blue plus red area; the seventh labeled area 707 is the white area. FIG. 8 illustrates a diagram depicting a dimming sequence by the dimming knob for mixing three color lights according to a preferred embodiment of the present invention. Referring to FIG. 7 and FIG. 8, when the dimming knob turns clockwise, its pointer would sequentially pass the red area 701, the red plus green area 702, the green area 703, the green plus blue area 704, the blue area 705, the blue plus red area 706 and the white area 707.

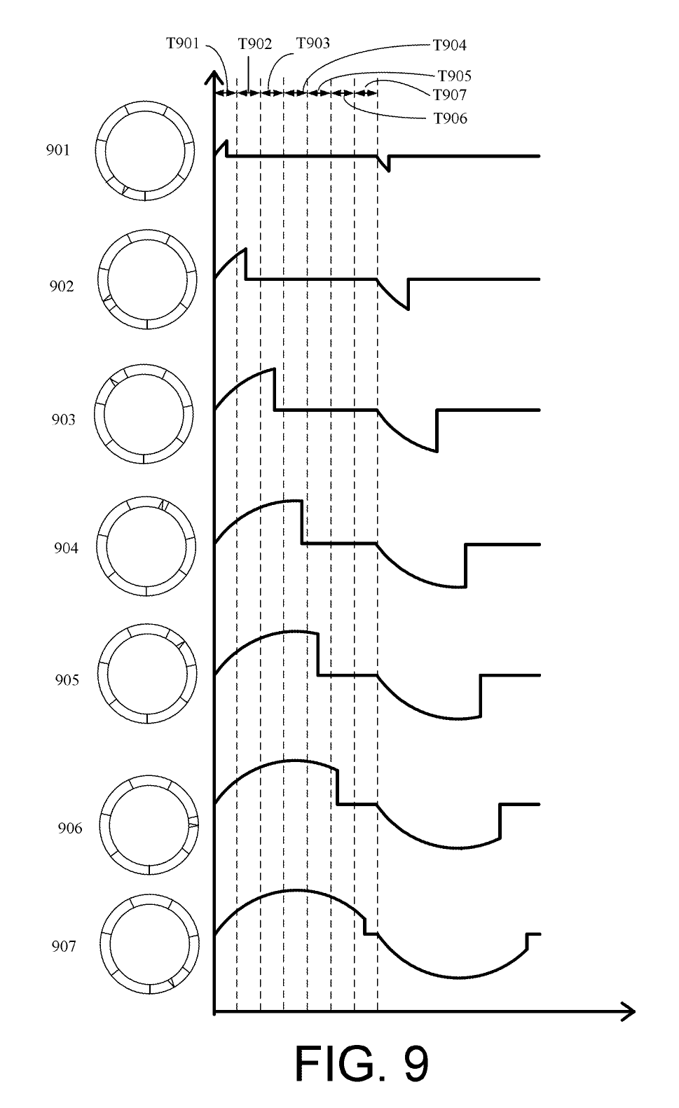

FIG. 9 illustrates a diagram depicting a relationship between the dimming knob in FIG. 7 and the waveforms of the power voltage according to a preferred embodiment of the present invention. Referring to FIG. 9, the label 901 shows a power voltage waveform when the red light of the dimmable lamp is lit up; the label 902 shows a power voltage waveform when the mixed light mixed by the red light and the green light of the dimmable lamp is lit up; the label 903 shows a power voltage waveform when the green light of the dimmable lamp is lit up; the label 904 shows a power voltage waveform when the mixed light mixed by the green light and the blue light of the dimmable lamp is lit up; the label 905 shows a power voltage waveform when the blue light of the dimmable lamp is lit up; the label 906 shows a power voltage waveform when the mixed light mixed by the blue light and the red light of the dimmable lamp is lit up; the label 907 shows a power voltage waveform when the white light of the dimmable lamp is lit up.

In addition, in order that people having ordinary skill in the art can understand the present invention, it is annotated the first phase period T901, the second phase period T902, the third phase period T903, the fourth phase period T904, the fifth phase period T905, the sixth phase period T906 and the seventh phase period T907 in the embodiment of FIG. 9. In other words, in this embodiment, the period of the power voltage is divided into the first phase period T901, the second phase period T902, the third phase period T903, the fourth phase period T904, the fifth phase period T905, the sixth phase period T906 and the seventh phase period T907. In this embodiment, it is assumed that the first phase period T901 represents the red light; the second phase period T902 represents the mixed light mixed by the green light and the red light; the third phase period T903 represents the green light; the fourth phase period T904 represents the mixed light mixed by the green light and the blue light; the fifth phase period T905 represents the blue light; the sixth phase period T906 represents the mixed light mixed by the blue light and the red light; and the seventh phase period T907 represents the white light.

Referring to FIG. 7 and FIG. 9, when user turns the dimming knob and its pointer stops in the red light area 701, the power voltage is chopped in the first phase period T901. When the control circuit 112 receives the chopped power voltage 901, the control circuit 112 lights the red lamp up. Similarly, in this embodiment, the control circuit 112 determines the luminance of the red lamp according to the chopped phase of the power voltage 901 in the first phase period T901. Since the abovementioned embodiment has already described, the detail description is omitted.

When user turns the pointer of the dimming knob to the red plus green light area 702, the power voltage is chopped at the second phase period T902. The control circuit 112 receives the chopped power voltage 902, the control circuit 112 lights the red lamp and the green lamp up. Similarly, in this embodiment, the control circuit 112 determines the luminance proportion between the luminance of the red lamp and the luminance of the green lamp according to the chopped phase of the power voltage 902 in the second phase period T902. For example, the second phase period T902 includes a first phase boundary and a second phase boundary. The first phase boundary of the second phase period T902 is between the first phase period T901 and the second phase period T902, and the second phase boundary of the second phase period T902 is between the second phase period T902 and the third phase period T903. If the chopped phase of the power voltage is closer to the first phase boundary of the second phase period T902, the luminance of the red lamp is stronger and the luminance of the green lamp is weaker. If the chopped phase of the power voltage is closer to the second phase boundary of the second phase period T902, the luminance of the red lamp is weaker and the luminance of the green lamp is stronger.

When user turns the pointer of the dimming knob to the green light area 703, the power voltage is chopped at the third phase period T903. When the control circuit 112 receives the chopped power voltage 903, the control circuit lights the green lamp up. Similarly, in this embodiment, the control circuit 112 determines the luminance of the green lamp according to the chopped phase of the power voltage 903 in the third phase period T903. Since the abovementioned embodiment has described, the detail description is omitted.

When user turns the pointer of the dimming knob to the green plus blue light area 704, the power voltage is chopped at the fourth phase period T904. When the control circuit 112 receives the chopped power voltage 904, the control circuit lights the green lamp and the blue lamp up. Similarly, in this embodiment, the control circuit 112 determines the luminance proportion between the luminance of the green lamp and the luminance of the blue lamp according to the chopped phase of the power voltage 904 in the fourth phase period T904. For example, the fourth phase period T904 includes a first phase boundary and a second phase boundary. The first phase boundary of the fourth phase period T904 is between the third phase period T903 and the fourth phase period T904, and the second phase boundary of the fourth phase period T904 is between the fourth phase period T904 and the fifth phase period T905. If the chopped phase of the power voltage is closer to the first phase boundary of the fourth phase period T904, the luminance of the green lamp is stronger and the luminance of the blue lamp is weaker. If the chopped phase of the power voltage is closer to the second phase boundary of the fourth phase period T904, the luminance of the green lamp is weaker and the luminance of the blue lamp is stronger.

When user turns the pointer of the dimming knob to the blue light area 705, the power voltage is chopped at the fifth phase period T905. When the control circuit 112 receives the chopped power voltage 905, the control circuit 112 lights the blue lamp up. Similarly, in this embodiment, the control circuit 112 determines the luminance of the blue lamp according to the chopped phase of the power voltage 905 in the fifth phase period T905. Since the abovementioned embodiment has described, the detail description is omitted.

When user turns the pointer of the dimming knob to the blue plus red light area 706, the power voltage is chopped at the sixth phase period T906. When the control circuit 112 receives the chopped power voltage 906, the control circuit lights the blue lamp and the red lamp up. Similarly, in this embodiment, the control circuit 112 determines the luminance proportion between the luminance of the blue lamp and the luminance of the red lamp according to the chopped phase of the power voltage 906 in the sixth phase period T906. For example, the sixth phase period T906 includes a first phase boundary and a second phase boundary. The first phase boundary of the sixth phase period T906 is between the fifth phase period T905 and the sixth phase period T906, and the second phase boundary of the sixth phase period T906 is between the sixth phase period T906 and the seventh phase period T907. If the chopped phase of the power voltage is closer to the first phase boundary of the sixth phase period T906, the luminance of the blue lamp is stronger and the luminance of the red lamp is weaker. If the chopped phase of the power voltage is closer to the second phase boundary of the sixth phase period T906, the luminance of the blue lamp is weaker and the luminance of the red lamp is stronger.

When user turns the pointer of the dimming knob to the white light area 707, the power voltage is chopped at the seventh phase period T907. When the control circuit 112 receives the chopped power voltage 907, the control circuit 112 lights the red lamp, the green lamp and the blue lamp up. Similarly, in this embodiment, the control circuit 112 determines the luminance of the red lamp, the green lamp and blue lamp according to the chopped phase of the power voltage 907 in the seventh phase period T907. Since the abovementioned embodiment has described, the detail description is omitted.

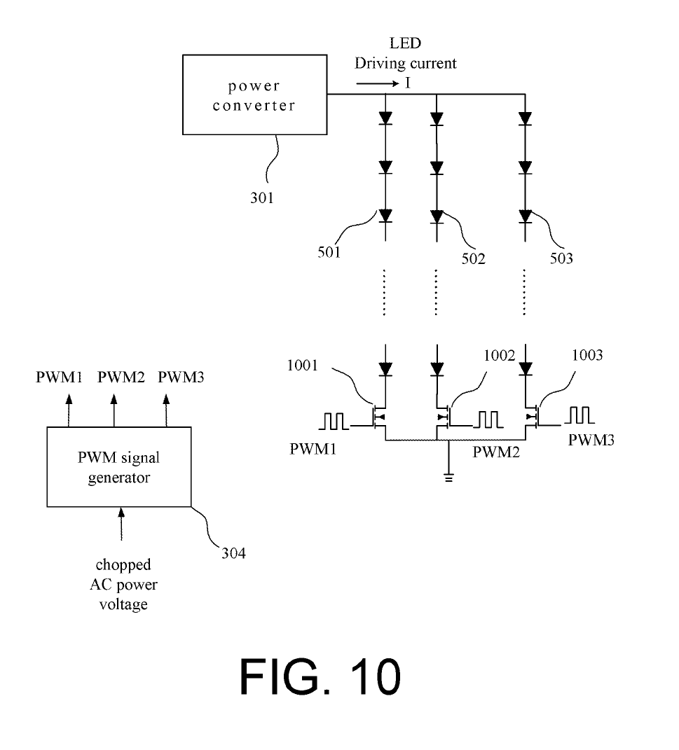

FIG. 10 illustrates a circuit diagram depicting a portion of the control circuit 112 according to a preferred embodiment of the present invention. Referring to FIG. 10, in this embodiment, the control circuit 112 includes a power converter 301, a first switch 1001, a second switch 1002, a third switch 1003 and a PWM signal generator 304. In addition, in this embodiment, the red lamp 501, the green lamp 502 and the blue lamp 503 respectively are implemented by the red light series LEDs 501, the green light series LEDs 502 and the blue light series LEDs 503. The power converter 301 is used for providing the driving currents for the red light series LEDs 501, the green light series LEDs 502 and the blue light series LEDs 503. The PWM signal generator 304 is used for providing the first PWM signal PWM1, the second PWM signal PWM2 and the third PWM signal PWM3 respectively to the first switch 1001, the second switch 1002 and the third switch 1003.

Similarly, in this embodiment, the duty cycles of the first PWM signal PWM1, the second PWM signal PWM2 and the third PWM signal PWM3 can be used for determining the currents respectively flowing through the red light series LEDs 501, the green light series LEDs 502 and the blue light series LEDs 503. Thus, their luminance and/or their light mixing ratio can be further adjusted.

For example, when user turns the pointer of the dimming knob to the red light area 701, the power voltage is chopped at the first phase period T901. When the PWM signal generator 304 receives the chopped power voltage 901, the PWM signal generator 304 determines the duty cycle of the first PWM signal PWM1 according to the phase different between the chopped phase of the power voltage 901 and the first phase boundary of the first phase period T901, wherein the first phase boundary of the first phase period T901 is for example zero degree. If the phase difference is greater, the duty cycle of the first PWM signal PWM1 is greater, and the current flowing through the red light series LEDs 501 is greater, and thus, the luminance of the red light series LED 501 is greater.

Next, when user turns the pointer of the dimming knob to the red plus green light area 702, the power voltage is chopped at the second phase period T902. When the PWM signal generator 304 receives the chopped power voltage 902, the PWM signal generator 304 controls the first PWM signal PWM1 and the second PWM signal PWM2 according to the phase difference between the chopped phase of the power voltage 902 and the first phase boundary of the second phase period T902, wherein the first phase boundary of the second phase period T902 is between the first phase period T901 and the second phase period T902. At this time, the first PWM signal PWM1 and the second PWM signal PWM2 have inverted phases from each other. Generally speaking, if the chopped phase of the power voltage 902 is closer to the first phase boundary of the second phase period T902, the duty cycle of the first PWM signal PWM1 is greater, and the duty cycle of the second PWM signal PWM2 is smaller.

When user turns the pointer of the dimming knob to the green light area 703, the power voltage is chopped at the third phase period T903. When the PWM signal generator 304 receives the chopped power voltage 903, the PWM signal generator 304 determines the duty cycle of the second PWM signal PWM2 according to the phase different between the chopped phase of the power voltage 903 and the first phase boundary of the third phase period T903, which is between the third phase period T903 and the second phase period T902. If the phase difference is greater, the duty cycle of the second PWM signal PWM2 is greater, and the current flowing through the green light series LEDs 502 is greater, and thus, the luminance of the green light series LED 502 is greater.

Next, when user turns the pointer of the dimming knob to the green plus blue light area 704, the power voltage is chopped at the fourth phase period T904. When the PWM signal generator 304 receives the chopped power voltage 904, the PWM signal generator 304 controls the second PWM signal PWM2 and the third PWM signal PWM3 according to the phase difference between the chopped phase of the power voltage 904 and the first phase boundary of the fourth phase period T904, which is between the fourth phase period T904 and the third phase period T903. In this embodiment, the second PWM signal PWM2 and the third PWM signal PWM3 have inverted phases from each other. Generally speaking, if the chopped phase of the power voltage 904 is closer to the first phase boundary of the fourth phase period T904, the duty cycle of the second PWM signal PWM2 is greater, and the duty cycle of the third PWM signal PWM3 is smaller.

When user turns the pointer of the dimming knob to the blue light area 705, the power voltage is chopped at the fifth phase period T905. When the PWM signal generator 304 receives the chopped power voltage 905, the PWM signal generator 304 determines the duty cycle of the third PWM signal PWM3 according to the phase different between the chopped phase of the power voltage 905 and the first phase boundary of the fifth phase period T905, which is between the fourth phase period T904 and the fifth phase period T905. If the phase difference is greater, the duty cycle of the third PWM signal PWM3 is greater, and the current flowing through the blue light series LEDs 503 is greater, and thus, the luminance of the blue light series LED 503 is greater.

Next, when user turns the pointer of the dimming knob to the blue plus red light area 706, the power voltage is chopped at the sixth phase period T906. When the PWM signal generator 304 receives the chopped power voltage 906, the PWM signal generator 304 controls the third PWM signal PWM3 and the first PWM signal PWM1 according to the phase difference between the chopped phase of the power voltage 906 and the first phase boundary of the sixth phase period T906, which is between the sixth phase period T906 and the fifth phase period T905. In this embodiment, the first PWM signal PWM1 and the third PWM signal PWM3 have inverted phases from each other. Generally speaking, if the chopped phase of the power voltage 906 is closer to the first phase boundary of the sixth phase period T906, the duty cycle of the third PWM signal PWM3 is greater, and the duty cycle of the first PWM signal PWM1 is smaller.

Finally, when user turns the pointer of the dimming knob to the white light area 707, the power voltage is chopped at the seventh phase period T907. When the PWM signal generator 304 receives the chopped power voltage 907, the PWM signal generator 304 determines the duty cycle of the first PWM signal PWM1, the duty cycle of the second PWM signal PWM2 and the duty cycle of the third PWM signal PWM3 according to the phase different between the chopped phase of the power voltage 907 and the first phase boundary of the seventh phase period T907, which is between the sixth phase period T906 and the seventh phase period T907. If the phase difference is greater, the duty cycle of the first PWM signal PWM1, the duty cycle of the second PWM signal PWM2 and the duty cycle of the third PWM signal PWM3 are greater, and the currents flowing through the red light series LEDs 501, the green light series LEDs 502 and the blue light series LEDs 503 are greater, and thus, the luminance of the white light is greater.

In summary, the spirit of the present invention resides in providing a plurality of mixed lighting modes corresponding to a plurality of phase periods in which a period of AC voltage is divided. In addition, the method switches the mixed lighting modes by chopping AC waveform in a single power wire. Thus, user can easily uses a dimmer knob to control the mixed lighting modes, and the light adjustment would become more intuitive.

In the abovementioned embodiments, all of the dimming control interfaces adopt dimming knob to be an example, people having ordinary skill in the art should know that the dimming knob is a more intuitive preferred embodiment, designer can also design a button interface. Thus, the present invention is not limited thereto.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A single-wire dimming method, adapted for a dimmable lamp, wherein the dimmable lamp comprises at least a first color lamp and a second color lamp, wherein a control circuit of the dimmable lamp receives a power voltage, and controls the first color lamp and a second color lamp, wherein the single-wire dimming method comprises:
providing a dimming interface, wherein the power voltage is chopped when the dimming interface is operated;
dividing a AC period of the power voltage into a first phase period, a second phase period and a third phase period;
chopping the power voltage at the first phase period when a user adjusts the dimmable lamp to show a first color light by the dimmable lamp;
chopping the power voltage at the third phase period when a user adjusts the dimmable lamp to show a second color light by the dimmable lamp; and
chopping the power voltage at the second phase period when a user adjusts the dimmable lamp to show a mixed color light by the dimmable lamp, wherein the mixed color light is mixed by the first color light and the second color light.

2. The single-wire dimming method according to claim 1, wherein when a user adjusts the dimmable lamp to show the first color light, the method further comprises:
determining the luminance of the first color light according to a chopped phase in the first phase period of the power voltage.

3. The single-wire dimming method according to claim 1, wherein when a user adjusts the dimmable lamp to show the second color light, the method further comprises:
determining the luminance of the second color light according to a chopped phase in the third phase period of the power voltage.

4. The single-wire dimming method according to claim 1, wherein when a user adjusts the dimmable lamp to show the mixed color light, the method further comprises:
determining the luminance of the first color light and the second color light according to a chopped phase in the second phase period of the power voltage.

5. The single-wire dimming method according to claim 4, wherein the first color lamp is a first color LED, and the second color lamp is a second color LED, and the single-wire dimming method further comprises:
providing a first pulse width modulation (PWM) signal;
providing a second pulse width modulation (PWM) signal;
providing a first switch, being electrically connected to the first color LED;
providing a second switch, being electrically connected to the second color LED;
determining a duty cycle of the first PWM signal according to a phase difference between the chopped phase in the second phase period of the power voltage and a first boundary phase of the second phase period when the power voltage is chopped at the second phase period; and
determining a duty cycle of the second PWM signal according to a phase difference between the chopped phase in the second phase period of the power voltage and a second boundary phase of the second phase period when the power voltage is chopped at the second phase period;
wherein the duty cycle of the first PWM signal determines the turn-on time of the first switch in a PWM period,
wherein the duty cycle of the second PWM signal determines the turn-on time of the second switch in the PWM period.

6. The single-wire dimming method according to claim 1, wherein the first color lamp is a warm white light lamp, and the second color lamp is a white light lamp, and the step of providing the dimming interface further comprises:
providing a dimmer knob, wherein the dimmer knob comprises a first adjusting boundary, a second adjusting boundary, a third adjusting boundary and a fourth adjusting boundary, wherein the first phase period comprises a first phase boundary and the second phase boundary, the second phase period comprises a first phase boundary and the second phase boundary, and the third phase period comprises a first phase boundary and the second phase boundary,
wherein the first adjusting boundary corresponds to the first phase boundary of the first phase period,
wherein the second adjusting boundary corresponds to the first phase boundary of the second phase period and the second phase boundary of the first phase period,
wherein the third adjusting boundary corresponds to the second phase boundary of the second phase period and the first phase boundary of the third phase period,
wherein the fourth adjusting boundary corresponds to the second phase boundary of the third phase period,
wherein the power voltage is chopped at the first phase period when a user turns the dimmer knob and a pointer of the dimmer knob stops at a position between the first adjusting boundary and the second adjusting boundary,
wherein the power voltage is chopped at the second phase period when a user turns the dimmer knob and the pointer of the dimmer knob stops at a position between the second adjusting boundary and the third adjusting boundary,
wherein the power voltage is chopped at the third phase period when a user turns the dimmer knob and the pointer of the dimmer knob stops at a position between the third adjusting boundary and the fourth adjusting boundary.

7. The single-wire dimming method according to claim 1, wherein the dimmable lamp further comprises a third color lamp, and the step of dividing the AC period of the power voltage into the first phase period, the second phase period and the third phase period comprises:
dividing the AC period of the power voltage into the first phase period, the second phase period, the third phase period and a fourth phase period; and

8. The single-wire dimming method according to claim 7, wherein the first color lamp is red lamp, the second color lamp is green lamp, the third color lamp is blue lamp, and the step of dividing the AC period of the power voltage into the first phase period, the second phase period, the third phase period and the fourth phase period comprises:
dividing the AC period of the power voltage into the first phase period, the second phase period, the third phase period, a fourth phase period, a fifth phase period, a sixth phase period and a seventh phase period;
chopping the power voltage at the fifth phase period when a user adjust the dimmable lamp to show a second mixed color light by the dimmable lamp, wherein the second mixed color light is mixed by the first color light and the third color light;
chopping the power voltage at the sixth phase period when a user adjust the dimmable lamp to show a third mixed color light by the dimmable lamp, wherein the third mixed color light is mixed by the second color light and the third color light; and
chopping the power voltage at the seventh phase period when a user adjust the dimmable lamp to show a fourth mixed color light by the dimmable lamp, wherein the fourth mixed color light is mixed by the first color light, second color light and the third color light.

9. A single-wire dimming method, adapted for a dimmable lamp, wherein the dimmable lamp comprises N color lamps, wherein a control circuit of the dimmable lamp receives a power voltage, and controls the N color lamps, wherein the single-wire dimming method comprises:
providing a dimming interface, wherein the power voltage is chopped when the dimming interface is operated;
dividing a AC period of the power voltage into M phase periods,
wherein M=C(N, 1)+C(N, 2)+ . . . +C(N, N),
where C (a, b)=a!/[b!×(b−a)!];
providing M light blend modes corresponding to the M phase period;
performing the I^{th} light blend mode by the dimmable lamp when a user adjust the dimmable lamp to chop the power voltage at the I^{th} phase period;
wherein the I^{th} light blend mode is to mix lights of K color lamps from N color lamps,
wherein N, M, K, I, a, b are nature numbers, and N is greater than or equal to K, and M is greater than or equal to I.

10. The single-wire dimming method according to claim 9, wherein the step of providing the dimming interface further comprises:
providing a dimmer knob, wherein the dimmer knob comprises M+1 adjusting boundaries, wherein each phase period comprises a first phase boundary and the second phase boundary,
wherein the I^{th} adjusting boundary corresponds to the first phase boundary of the I^{th} phase period,
wherein the (I+1)^{th} adjusting boundary corresponds to the first phase boundary of the (I+1)^{th} phase period and the second phase boundary of the I^{th} phase period,
wherein the power voltage is chopped at the Q^{th} phase period when a user turns the dimmer knob and a pointer of the dimmer knob stops at a position between the Q^{th} adjusting boundary and the (Q+1)^{th} adjusting boundary,
wherein Q is a nature number, and M is greater than Q.
